(19) United States
(12) Patent Application Publication
(10) Pub. No.: US 2026/0223764 A1
(43) Pub. Date: Aug. 6, 2026

(54) A METHOD AND APPARATUS FOR PLANTING SEEDS

(71) Applicant: S+dB B.V., Nederweert (NL)

(72) Inventors: Gerard OTTEN, Nederweert (NL); Harrie VERSTEEG, Nederweert (NL); Marco RIJSTENBIL, Nederweert (NL)

(21) Appl. No.: 19/150,938

(22) PCT Filed: Jan. 26, 2024
(86) PCT No.: PCT/EP2024/051983

§ 371 Date: Jul. 25, 2025

(30) Foreign Application Priority Data
Jan. 26, 2023 (EP) 23153482.7

(51) Int. Cl. A01C 7/04; A01C 1/04; A01C 5/06; A01C 7/20

(52) U.S. Cl. CPC A01C 7/048; A01C 1/042; A01C 5/064; A01C 7/203

(57) ABSTRACT

The invention provides a method for sowing seeds in a soil substrate, the seeds being carried by a seed tape; which method comprises advancing along the soil substrate a carriage provided with a seed tape feeder, a rotating pressing disc and optionally rotating soil cutting disc, the rotating pressing disc being mounted on the carriage in-line behind the soil cutting disc when such is present; such that:
(i) the rotating soil cutting disc when present cuts a longitudinally extending substantially vertical slit as the carriage advances along the soil substrate;
(ii) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the slit (or into the soil to form a slit when no cutting disc is present, as the carriage advances, such that after being pressed into the slit, the longitudinal fold in the seed tape is downwardly oriented and the two edges of the seed tape are upwardly oriented, and there is a vertical gap between the two edges and an upper end of the slit;
   as well as an apparatus for carrying out the method.

The invention relates to a method of planting seeds which comprises planting a seed tape in the ground and to an apparatus for performing the method.

### BACKGROUND OF THE INVENTION

It is known that by enhancing the precision with which seeds are planted, the germination of the seeds and the early uniform growth of both sprout and root are improved. The use of seed tapes offers many opportunities for enhancing the precision of seed planting and allows seeds to be planted with very high precision. Such seed tapes typically comprise one or more layers or sheets of paper, woven or nonwoven fabrics, plastic films, mulch mats, or combinations thereof to which seeds are adhered or between which seeds are sandwiched.

Our earlier patent EP 3 403 483 discloses seed tapes formed from self-supporting films of a water-based polymer such as polyvinyl alcohol.

U.S. Pat. No. 4,173,844 (Knolle et al.) discloses laminar seed carriers comprising two layers having different characteristics bonded together and seeds held between the layers. The seed carriers would appear to be intended to be laid horizontally on the ground.

Other methods of preparing seed tapes or seed carriers are described in EP 0953280 (Coudrieau et al.) and KR100759274.

U.S. Pat. No. 5,165,351 (Billings) discloses an apparatus and method for laying a seed tape. In the Billings method, a furrow is created by a “furrow opener” at the leading end of a seed planter unit and the seed tape is laid horizontally into the furrow and then covered by soil.

In most known systems for seeding using seed tapes, the seed tape is laid flat against the soil or the bottom of a furrow and it is typically necessary to hold the seed tapes down with soil, sand or like materials to prevent them from being blown away. In a departure from this practice, U.S. Pat. No. 2,571,491 describes a seeding method in which the seed tape is laid mainly in a vertical plane. Thus, U.S. Pat. No. 2,571,491 discloses a seed tape formed from two similar strips of porous non-absorbing paper glued together over part of their width to form a sandwich structure with seeds being held in the glue between the strips. In use, a slit trench or furrow is formed in the ground and the seed tape is inserted in a vertical orientation into the slit trench such that a proportion of the tape protrudes above the ground. Soil is pressed against opposite sides of the seed tape to hold it in place and the upper edges (which are not glued together) are then folded back to lie flat against the soil. The purpose of the folded back edges is to provide protected areas on either side of the seed row. One problem with the method disclosed in U.S. Pat. No. 2,571,491 is how to press the soil against the sides of the seed tape to hold it in place. It is easy to imagine how this could be done manually, but less easy to envisage how it could be done quickly and accurately by mechanical means, and U.S. Pat. No. 2,571,491 contains no disclosure of any machinery that could be used for this purpose. A further potential problem with the method disclosed in U.S. Pat. No. 2,571,491 is that the folded back edges could lift in windy conditions, and this could result in the seed strip being pulled out of the furrows. A still further problem is that the folded back edges protruding above the soil are unlikely to be degraded by soil-borne organisms and therefore will persist for longer as residues which may become entangled with growing plants and may inhibit mechanical weeding methods.

U.S. Pat. No. 5,906,167 (Miyachi) discloses an apparatus for planting a net tape containing grass runners using an apparatus which cuts a slit in the ground and presses a folded net tape into the slit. U.S. Pat. No. 5,906,167 does not disclose the use of the apparatus for installing seed tapes in the ground and it is considered that the apparatus disclosed therein would not in fact be suitable for installing seed tapes in the ground.

At the present time, therefore, there remains a need for improved methods of sowing seeds using seed tape technology.

### THE INVENTION

The present invention provides a method for planting a seed tape in a soil substrate which, in one aspect, involves cutting a continuous substantially vertical slit in the soil and then installing the seed tape in the substantially vertical slit. In order to avoid the need to create a wider furrow to allow installation of the seed strip and then backfill with soil, the method of the invention involves folding the seed tape so that the fold faces downwards, and then pressing the folded seed trip down into the slit using a pressing disc which engages the inner surface of the fold. Once the seed tape has been pressed down into the slit, in contrast to the method described in U.S. Pat. No. 2,571,491, there is no need for further disturbance of the soil.

A major difference between the method of the present invention and the method described in U.S. Pat. No. 2,571,491 is that, in the method of the present invention, the seed tape is installed in the slit such that there is a vertical gap between the top of the slit and the top edges of the seed tape; i.e. the top edges of the seed tape are recessed below ground level This has several advantages:
Because there are no protruding sections of the seed tape above ground, the seed tape cannot be caught by the wind and pulled out of the slit, and thus the seed tapes are more firmly anchored in the soil.
There are no protruding sections of seed tape above ground that can act as wicks to draw moisture out of the slit and away from the seeds where the moisture is needed.
The space in the slit above the seed tape provides room for the stems and leaves of seedlings to grow before they emerge above the surface, thereby providing the growing seedlings with a degree of protection at a vulnerable time in their development.
There are no seed tape residues left above the surface of the ground which can become entangled with growing plants and can interfere with mechanical weeding methods. This also avoids the contamination of crops such as fresh vegetables, e.g. spinach, with paper which is not acceptable or allowed under food industry standards.
Because the seed tape is wholly below the ground, it will tend to absorb and concentrate moisture from the surrounding soil thereby assisting seed germination and early growth of the plants in drier conditions. By contrast, the seed tape of U.S. Pat. No. 2,571,491 has sections that extend above ground and therefore provide a means for wicking moisture away from the plants.
Because the seed tape is wholly below ground, it has greater exposure to soil organisms that can bring about biodegradation of the seed tape once the seeds have germinated. By contrast, the regions of seed tape extending above ground in the method of U.S. Pat. No. 2,571,491 will not be subjected to the same degree of exposure to soil organisms and would be expected therefore to degrade more slowly and therefore persist on the surface of the soil for longer.

In some of the methods of the present invention, a vertical slit is cut into the soil and then the seed tape is pressed into the slit with a pressing disc. These methods of the invention allow the seed tape to be pressed into the slit to a selected and controlled depth, the depth being selected according to the nature of the seeds being planted. In contrast to the method described in U.S. Pat. No. 2,571,491, not only does the method of the invention enable the seed tape to be installed in the slit so that it is wholly below ground level, but it is also typically installed so that there is a vertical gap beneath the seed tape as well as above it. The advantage of the vertical gap beneath the seed tape is that there is no vertical resistance to root growth and therefore roots can become established more quickly.

The pressing disc can be controlled, and/or its dimensions and/or weight selected, so the seed tape is installed in the ground at a desired depth in the slit. The depth of the seeds is in turn controlled by the placement of the seeds on the tape during the manufacture of the seed tape. Thus, the depth at which the seed is planted in the soil can be controlled and optimized for different seed types.

A general advantage over known seeding methods is that the present method involves far less disturbance to the soil and therefore far less interference with the soil structure and soil life. It is possible to use the method of the present invention on undisturbed surfaces as well as surfaces that have previously been ploughed or furrowed. Certain methods of the present invention use a cutting disc to cut the slit and the cutting disc is able to cut slits in soils in a wide range of soils and soil conditions. Thus, the method of the invention can reduce the amount of time spent in soil preparation prior to planting.

The method of the invention enables seeds to be planted very accurately in very straight lines which allows subsequent hoeing between seed lines to be carried out more easily and accurately.

A further and substantial advantage over known seeding methods is that the method of the invention provides a greater window of opportunity for carrying out planting. The window of opportunity for planting typically depends on the weather and wetness of the soil. Existing methods of planting are prevented or inhibited if the soil is too wet and clogging of soil preparation and planting machinery with wet soil occurs. Because the method of the present invention requires only minimal disruption to the soil, and because the pressing disc used to press the seed tape into the ground is protected from clogging by the folded seed tape, the method of the present invention can be used in soils having a wider range of moisture contents. The method of the present invention may therefore be used when the soil is too wet for many other planting methods.

The present invention also provides an apparatus for carrying out the method of the invention. The apparatus comprises a carriage upon which are mounted a seed tape feeder and a pressing disc for pressing the seed tape into the slit, and optionally a soil cutting disc for cutting a slit. The components of the apparatus are arranged so that the seed tape is fed into the path of the pressing disc such that ribbon wraps around a peripheral pressing edge of the pressing disc thereby creating a longitudinal fold in the ribbon. The pressing disc then presses the folded ribbon down into the slit (or directly into the soil to create a slit if no cutting disc is used), the peripheral pressing edge of the pressing disc acting on the inner surface of the fold. The pressing disc may be provided with a shoulder on one or both sides thereof, the shoulder(s) being set back from the peripheral edge. The shoulder(s) press into the soil to create an enlarged region at the upper end of the slit.

Accordingly, in a first aspect (Embodiment 1.0), the invention provides a method for sowing seeds in a soil substrate, the seeds being carried by a seed tape; which method comprises:
(i) optionally cutting a longitudinally extending substantially vertical slit along the soil substrate;
(ii) feeding the seed tape in front of a pressing disc and bringing the seed tape into contact with the pressing disc so that a peripheral pressing edge of the pressing disc is substantially centrally aligned between two edges of the seed tape;
(iii) advancing the pressing disc along a path (e.g. a path aligned with the slit) so that it progressively creates a longitudinal fold in the seed tape and progressively presses the folded seed tape into the slit (or directly into the soil to create a slit where pre-cut slit), whereby, after being pressed into the slit (or soil), the longitudinal fold in the seed tape is downwardly oriented and the two edges of the seed tape are upwardly oriented, and there is a vertical gap between the two edges and an upper end of the slit.

In another aspect (Embodiment 1.01), the invention provides a method for sowing seeds in a soil substrate, the seeds being carried by a seed tape; which method comprises:
(i) providing an apparatus comprising a carriage having mounted thereon a seed tape feeder, and a rotating pressing disc, wherein the apparatus comprises a force adjustment mechanism for adjusting a pressing force exerted by the pressing disc against the soil substrate;
(ii) using the force adjustment mechanism to select a force setting for the pressing disc to provide a desired degree of penetration of the pressing disc into the soil substrate;
(ii) feeding the seed tape in front of the pressing disc and bringing the seed tape into contact with the pressing disc so that a peripheral pressing edge of the pressing disc is substantially centrally aligned between two edges of the seed tape;
(iv) advancing the carriage along a path such that, as the carriage advances, the pressing disc progressively creates a longitudinal fold in the seed tape and progressively presses the folded seed tape into the soil substrate, whereby, after being pressed into the soil substrate, the longitudinal fold in the seed tape is downwardly oriented and the two edges of the seed tape are upwardly oriented and are below ground level.

A substantial advantage of enabling the force applied by the pressing disc to be varied is that the depth to which the seed tape is installed in the substrate can be controlled more precisely.

A substantial proportion of the force applied by the pressing disc to the soil substrate is due to the weight of the pressing disc. However, the force due to the weight of the pressing disc can be augmented or reduced by the force adjustment mechanism.

The force adjustment mechanism can comprise a spring and a tensioning device for varying the tension in the spring, the spring being oriented such that the tension in the spring either augments or reduces the force applied by the pressing disc to the soil substrate due to the weight of the pressing disc.

Such an advantage is absent from the apparatus described in U.S. Pat. No. 5,906,167 where the pressing disc appears to have a fixed height and cannot be adjusted to provide planting to different depths in the soil.

In one embodiment, the spring is oriented such that the tension in the spring augments the force applied by the pressing disc to the soil substrate due to the weight of the pressing disc.

In another embodiment, the spring is oriented such that the tension in the spring reduces the force applied by the pressing disc to the soil substrate due to the weight of the pressing disc.

The term “spring” as used herein refers not only to mechanical springs but also to hydraulic or gas springs. It will be appreciated that instead of a spring, other force adjustment mechanisms may be used.

The pressing disc is typically mounted on a frame (sub-assembly) which can move up and down thereby reducing or increasing the force applied by the pressing disc to the soil substrate. The force adjustment mechanism is linked to the frame (sub-assembly) and controls or moderates up or down movement of the frame.

For example, the force adjustment mechanism (such as a spring) can be arranged to oppose downward movement of the frame, thereby reducing the force applied by the pressing disc to the soil substrate. Alternatively, the force adjustment mechanism can be configured to provide a downwards biassing force to the frame thereby augmenting the force applied by the pressing disc to the soil substrate.

In some embodiments of the invention, the pressing disc and the cutting disc (when present) are mounted on a sub-assembly which is linked to a main support frame of the carriage by upper and lower arms arranged in a parallelogram configuration, each vertex of the parallelogram constituting a pivot point such that the angles of the parallelogram can be changed; wherein a tensioning element (such as a spring) is disposed between opposing sides and/or vertices of the parallelogram, the tensioning element being adjustable to change the parallelogram configuration to increase or reduce the downforce exerted by the pressing disc on the soil substrate.

An advantage of using a force adjustment mechanism comprising a spring is that the spring is able to compensate for undulations in the underlying soil substrate thereby assisting the pressing disc to achieve a more closely controlled soil penetration depth.

The method of Embodiments 1.0 and 1.01 may optionally comprise the step of cutting a longitudinally extending substantially vertical slit along the soil substrate, into which the folded seed tape is pressed. Whether or not it is necessary to cut a slit into which the seed tape is pressed will depend on the condition of the soil. In some cases, the soil substrate may be soft enough to enable the seed tape to be pressed into the soil substrate without first cutting a slit. In other cases, the soil substrate may be too hard for the seed tape to be installed using the pressing disc alone and it may be necessary or desirable first to cut a slit.

Thus, the apparatus used to perform the method of the invention may optionally be provided with a cutting disc, which cutting disc may either be removed/added as required or may be capable of being raised or lowered to bring it into or out of contact with the soil substrate.

The force adjustment mechanism is typically set so that the pressing disc presses the seed tape into the soil substrate so that the longitudinal fold in the seed tape is at a depth of from about 1 cm to about 10 cm.

The longitudinally extending substantially vertical slit is typically cut into the substrate using a rotating soil cutting disc mounted in front of the pressing disc on a suitable mobile support structure, e.g. a carriage.

In a third aspect, (Embodiment 1.1), the invention provides a method for sowing seeds in a soil substrate, the seeds being carried by a seed tape; which method comprises advancing along the soil substrate a carriage provided with, a seed tape feeder, and a rotating pressing disc, and optionally a rotating soil cutting disc; the seed tape feeder and rotating pressing disc being mounted on the carriage in-line behind the soil cutting disc when present; such that:
(i) the rotating soil cutting disc when present cuts a longitudinally extending substantially vertical slit as the carriage advances along the soil substrate;
(ii) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the slit, or directly into the soil to form a slit if no cutting disc is used as the carriage advances, such that after being pressed into the slit, the longitudinal fold in the seed tape is downwardly oriented and the two edges of the seed tape are upwardly oriented, and there is a vertical gap between the two edges and an upper end of the slit.

Thus, according to the invention, a longitudinally extending substantially vertical slit is cut into the soil substrate by the soil cutting disc and the seed tape is progressively folded and pressed into the slit, or directly into the ground to form a slit, as the carriage advances along the soil substrate. The fold is a longitudinal fold and results in the seed tape being wrapped around the peripheral pressing edge of the pressing wheel as it is pressed into the slit.

The longitudinal fold is typically made along a line approximating to the centre line of the seed tape; i.e. its longitudinal axis of symmetry.

The slit may extend longitudinally over a distance depending on the length of the field or area of cultivation in which the seeds are to be planted.

The folded seed tape is pressed into the slit in the soil substrate (or directly into the soil substrate when no slit is cut) such that the uppermost parts of the seed tape (i.e. the two upwardly oriented edges) are below ground level; i.e. there is a vertical gap between the two upwardly oriented edges and an upper end of the slit.

The slit (whether made by a cutting disc or by the pressing disc) is preferably formed so that, at an upper end thereof, it has an enlarged region. The enlarged region may be defined by sloping and/or curved walls that diverge towards the top of the slit. The sloping walls, which may be straight or curved, or a combination thereof, provide the slit with an enlarged region, the purpose of which is to provide room for growth of the leaves of seedlings before they emerge above ground level.

In one embodiment, the enlarged region or channel is substantially V-shaped in cross section. In another embodiment, the enlarged region or channel is cup-shaped in cross section.

It will be appreciated from the foregoing that an enlarged region or channel may also be formed by pressing the seed tape directly into the ground without first cutting a slit, provided that the soil substrate is soft enough.

In addition to providing room for growth of the leaves of seedlings before they emerge above ground level (e.g. above a field surface level), the enlarged regions at the top of the slit, particularly when V-shaped, help to funnel rainwater or other irrigation water into the slits.

The enlarged region or channel is formed by an appropriately shaped shoulder on one or both sides of the pressing disc. The shoulder(s) can be formed integrally with the pressing disc, or the shoulder(s) may be formed separately and secured to the pressing disc. The shoulder(s) may, for example, be formed from a suitably tough plastics material.

There is a radial spacing between the shoulder(s) and the peripheral pressing edge of the pressing disc. The radial spacing is typically at least 1 cm in size and more usually is at least 1.5 cm in size, for example from 1.7 cm to 2 cm. The radial spacing is selected according to the width (before folding) of the seed tape and is typically approximately half the width of the seed tape before folding. Consequently, after the seed tape has been folded, the two lateral edges of the seed tape will lie in close proximity to the radially outermost edge of the shoulder(s).

When the slit is pre-cut using a cutting disc, the depth of the slit (including any enlarged upper end thereof) is typically larger than the vertical dimension of the seed tape when it has been pressed into the slit. Thus, the depth of the slit may be selected such that there is always a vertical space beneath the folded seed tape into which the roots of germinating seeds can grow.

Thus, in one preferred embodiment, after the folded seed tape has been pressed into the slit, the folded seed tape is positioned such that the upwardly oriented edges of the folded seed tape are located adjacent a lower end of an enlarged region of the slit (and preferably are located below the lower end of the enlarged region of the slit) and there is a vertical gap between the longitudinal fold in the seed tape and the bottom of the slit.

The positioning of the seed tape in the slit is such that, once seeds have germinated, the roots of the seedling are able to grow downwards into the space below the seed tape and into the surrounding soil and the stem and leaves of the seedling are able to grow into the enlarged region at the upper end of the slit. Thus, the growing seedlings are sheltered from the effects of wind and are better able to thrive.

The depth of the slit and the size (width and vertical depth) of the enlarged region of the slit may be chosen according to the nature and dimensions of the plant. By way of example, the slit may be from 5 to 20 cm deep (for example 5 cm to 10 cm deep) and may have an enlarged upper region of from 0 cm to 5 cm, for example 1.5 cm to 5 cm deep (e.g. 2 cm to 3 cm deep) and a width, at its upper end of from 0 cm to 5 cm, for example from 1.5 cm to 3 cm.

The seed tape is fed in front of the pressing disc by the seed tape feeder which typically comprises a roll of the seed tape and one or more guide rollers for guiding the seed tape into place. The positioning of the guide rollers is typically selected such that the seed tape is brought into contact with the pressing disc at a point approximately at the top of the slit. Alternatively, the seed tape can be brought into contact with the pressing disc at a point above the top of the slit so that folding can commence. In a further alternative, the guide roller(s) can be arranged to lay the seed tape on top of the soil substrate over the slit prior to contact with the pressing disc.

Although the roll of seed tape may be mounted on the carriage such that it has an axis of rotation parallel to the axis of rotation of the pressing disc and is in-line with the pressing disc, it has been found that more accurate alignment of the pressing disc with the centre line of the seed tape (i.e. its longitudinal axis of symmetry) can be achieved by mounting the roll of seed tape such that the seed tape is initially unwound in a substantially lateral direction, and then using a turn roller to turn the direction of travel of the seed tape through so that it is in-line with the pressing disc. Unwinding the seed tape roll initially in a lateral direction and then turning the direction of travel by means of the turn roller appears to reduce unwanted lateral migration of the seed tape caused by any swaying motion of the carriage due to travel over uneven ground.

The roll of seed tape may be mounted on the carriage such that its axis of rotation is substantially perpendicular to the axis of rotation of the pressing disc. In this case, the turn roller turns the direction of travel of the seed tape through an angle of approximately 90°. It will be appreciated however that the angle does not need to be exactly perpendicular, and may vary by, for example, ±10° from perpendicular.

The seed tape is an elongate length of seed-containing or seed-bearing strip which is typically formed from a cellulose-based and/or plastics-based material and carries seeds. The seeds may be sandwiched between layers of the seed tape or adhered to a surface thereof. Examples of seed tapes are the seed tapes disclosed in our earlier International Patent Application No. PCT/EP/2020/059291 (WO2020/201373), the contents of which are incorporated herein in their entirety.

Thus, for example, the seed tape can comprise a polymer film layer having a plurality of seeds at least partially embedded therein, and a porous reinforcing layer bonded or laminated to the polymer film layer. In this embodiment, when the seed tape is folded, the porous reinforcing layer preferably constitutes the inner surface of the folded ribbon so that the seed-containing polymer film layer faces outwards.

The seed tapes are typically capable of being wound into a roll for storage and dispensing purposes.

The seed tapes have a sufficiently high tensile strength to ensure that they do not break during installation in the soil substrate. Preferably, therefore, the seed tapes should have a wet strength MD (i.e. in the machine direction) of at least 100 N/5 cm (as determined by standard ISO 9073-3).

Prior to folding and installation in the slits, the seed tapes can have a width of from about 3 cm to 8 cm, for example from about 3.5 cm to about 5.5 cm.

The seed tapes can have a thickness (disregarding the size of any seeds adhered to the tapes but including any coatings on a carrier) of from about 0.5 mm to about 5 mm but typically from 0.6 mm- 1 mm.

The seed tapes can be prepared under controlled factory conditions so that seeds can be deposited onto or incorporated into the tapes in a highly precise manner thereby allowing for very precise planting patterns when the seed tapes are installed in the ground. For example, a row of seeds may be incorporated into the seed tape wherein the said row of seeds is at a predefined distance from the edge of the seed tape and is substantially parallel thereto. The distance between the row of seeds and the edge of the seed tape will determine the depth at which the seeds are planted in the ground. A variety of different seed tapes may be prepared, each bearing a row of seeds at a selected distance from the edge of the seed tape to allow planting of the seeds at an optimal depth for a plant species or type in question.

Thus, in accordance with the invention, the depth to which the seed tape is pressed into the ground is determined by the downforce applied by the pressing disc but the depths to which different seed types are planted is determined by the position of the seeds on the seed tape.

In another aspect, the invention provides a seed tape as hereinbefore defined, the seed tape being formed from a cellulose-based and/or plastics-based material and carrying seeds arranged in a row extending along the seed tape, the row being substantially parallel to a longitudinal edge of the seed tape and being spaced apart from a centre line of the seed tape.

The seed tape can comprise a polymer film layer having a plurality of seeds at least partially embedded therein and arranged in a said row, and a porous reinforcing layer bonded or laminated to the polymer film layer. In this embodiment, when the seed tape is folded, the porous reinforcing layer preferably constitutes the inner surface of the folded ribbon so that the seed-containing polymer film layer faces outwards.

The seed tape may have only a single row of seeds, the single row of seeds typically consisting of seeds of a single plant type.

The invention also provides methods and apparatus as hereinbefore defined comprising or making use of such seed tapes.

The seed tapes used in the method and apparatus of the invention can contain one or more active ingredients for enhancing the germination or growth of plants from the seeds, or for controlling or eradicating pests. Thus, for example, the seed tapes can contain one or more active ingredients selected from plant growth additives; soil-adjustment additives; extender and/or seed protection additives; bio-stimulants such as humic acid, fulvic acid and plant hormones (e.g. gibberellins and auxins); nitrogen containing compounds; inorganic compounds; salt binding agents such as gypsum (calcium sulphate); micro-nutrients (such as zinc, copper, boron, and seaweed extracts); botanicals; chitosan; biopolymers; biological agents such as fungi (e.g. mycorrhizal fungi) or bacteria (e.g. beneficial soil bacteria); organic or synthetic fertilizers; biocontrol agents such as pesticides, herbicides, fungicides, insecticides, wool fibres (for deterring slugs); pH-modifiers such as calcium carbonate, lime and sulphur; UV-stabilisers; water absorbing and retaining materials such as silica, bentonite clays; talcum; pigments and colour dyes.

Such additives will typically be present in amounts corresponding to 0-50% (w/w), more usually 0-25% (w/w), for example 0-10% (w/w), or 0-5% (w/w) of the biodegradable polymer membrane.

It will be appreciated that the active ingredients will be selected so as to be beneficial (and hence non-toxic) to the growth and development of a plant species of interest from the seeds. Thus, for example, if herbicides are included, they will be selective herbicides that do not harm the plant species of interest.

A range of microbiological additives can be incorporated into the seed tapes to assist germination and plant establishment. These are typically mycorrhizal fungi. Mycorrhizae are a group of about 400 fungi that form symbiotic relationships with plants. They live in or on the roots, extend their hyphae into the soil and make phosphate, nitrogen other nutrients and water available to the host plant. They extend the effective root area many hundreds of times so plants grow faster, larger and stronger with less fertiliser and water. Other commercially available biological and chemical agents that stimulate plant defences and encourage beneficial symbiotic mycorrhizal associations may also be included.

The buffering and other chemical organic agents provide a means of counteracting the impact of adverse chemical contaminants in the soil or medium, as well as improving germination, and/or aiding and accelerating plant establishment. Thus, for example, lime provides a buffer against low pH, gypsum provides a means of counteracting high salinity, whereas clay minerals such as zeolite, kaolinite, calcium bentonite and montmorillonite counteract high levels of fertiliser or chemical contamination in the soil.

It will be appreciated that the additives should preferably be biodegradable or should be safely incorporated into the substrate (soil) after the crops have been harvested and that the components do not provide any health concerns, which would render the crops grown from the seeds as unsuitable for human consumption.

It will be appreciated from the above that the method and apparatus of the invention provide a very effective means for the controlled introduction into the soil of a range of substances that are beneficial to the germination of seeds and subsequent growth and development of the resulting plants. The substances can be incorporated into the seed tapes in the required amounts under highly controlled factory conditions and therefore the amounts of such substances delivered to the soil along with the seeds can be controlled in a highly accurate manner.

It will be appreciated from the foregoing that particular embodiments of the method of the invention are as set out in Embodiments 1.2 to 1.19 below.
1.2 A method according to any one of Embodiments 1.0 to 1.1 wherein the longitudinal fold is made along a line approximating to the centre line of the seed tape; i.e. its longitudinal axis of symmetry.
1.3 A method according to any one of Embodiments 1.0 to 1.2 wherein (i) where a slit is formed into which the seed tape is pressed, the slit is formed so that, at an upper end thereof, it has an enlarged region; or (ii) when no slit is initially formed but the seed tape is pressed directly into the soil substrate, an enlarged region or channel is created above the folded seed tape after it has been pressed into the soil substrate.
1.4 A method according to Embodiment 1.3 wherein (i) the enlarged region is defined by sloping and/or curved walls that diverge towards the top of the slit; or (ii), where no slit is initially formed, the enlarged region or channel is defined by sloping and/or curved walls that diverge towards the top thereof.
1.5 A method according to Embodiment 1.3 wherein the enlarged region or channel has a substantially V-shaped cross section.
1.6 A method according to Embodiment 1.3 wherein the enlarged region or channel is cup-shaped in cross section.
1.7 A method according to any one of Embodiments 1.3 to 1.6 wherein the enlarged region or channel is formed by an appropriately shaped shoulder on one or both sides of the pressing disc.
1.8 A method according to Embodiment 1.7 wherein there is a radial spacing between the shoulder(s) and a peripheral pressing edge of the pressing disc which is at least 1 cm in size.
1.9 A method according to Embodiment 1.8 wherein the radial spacing is at least 1.5 cm in size, for example from 1.7 cm to 2 cm.
1.10 A method according to any one of Embodiments 1.0 to 1.9 wherein the depth of the slit (including any enlarged upper end thereof) is larger than the vertical dimension of the seed tape when it has been pressed into the slit and is selected such that there is a vertical space beneath the folded seed tape into which the roots of germinating seeds can grow.
1.11 A method according to any one of Embodiments 1.0 to 1.10 wherein the slit is from 5 to 20 cm deep (for example 5 cm to 10 cm deep).
1.11A A method according to any one of Embodiments 1.0 to 1.11 wherein the downwardly oriented longitudinal fold in the seed tape is pressed into the ground to a depth of from 1.5 cm to 5 cm.
1.12 A method according to Embodiment 1.3 and any Embodiment referring thereto the enlarged upper region is from 0 cm to 5 cm deep, for example 1.5 cm to 5 cm deep (e.g. 2 cm to 3 cm deep).
1.12A A method according to Embodiment 1.12 wherein the enlarged upper region has a width, at its upper end of from 0.5 cm to 5 cm, for example from 1.5 cm to 3 cm.
1.13 A method according to any one of Embodiments 1.0 to 1.12 wherein the seed tape is an elongate length of seed-containing or seed-bearing strip which is formed from a cellulose-based and/or plastics-based material and carries seeds, and wherein the seeds are sandwiched between layers of the seed tape or are adhered to a surface thereof.
1.14 A method according to Embodiment 1.13 wherein the seed tape comprises a polymer film layer having a plurality of seeds at least partially embedded therein, and a porous reinforcing layer bonded to the polymer film layer.
1.15 A method according to Embodiment 1.14 wherein, when the seed tape is folded, the porous reinforcing layer constitutes the inner surface of the folded ribbon so that the seed-containing polymer layer faces outwards.
1.16 A method according to any one of Embodiments 1.0 to 1.15 wherein the seed tape feeder comprises a roll or reel of the seed tape.
1.16A A method according to Embodiment 1.16 wherein the seed tape is unwound so that it initially travels in a lateral direction and a turn roller is employed to turn the direction of travel to bring it in-line with the pressing disc.
1.17 A method according to any one of Embodiments 1.0 to 1.16A wherein the seed tapes have a wet tensile strength (MD) of at least 100 N/5 cm.
1.18 A method according to any one of Embodiments 1.0 to 1.17 wherein, prior to folding and installation in the soil substrate, the seed tapes have a width of from about 3 cm to 8 cm, for example from about 3.5 cm to about 5.5 cm.
1.19 A method according to any one of Embodiments 1.0 to 1.18 wherein the seed tapes have a thickness (disregarding the size of any seeds adhered to the tapes) of from about 0.5 mm to about 5 mm, for example from 0.6-1 mm.
1.20 A method according to any one of Embodiments 1.0 to 1.19 wherein the seed tapes contain one or more active ingredients for enhancing the germination or growth of plants from the seeds, or for controlling or eradicating pests.
1.21 A method according to Embodiment 1.20 wherein the seed tapes contain one or more active ingredients selected from plant growth additives; soil-adjustment additives; extender and/or seed protection additives; bio-stimulants such as humic acid, fulvic acid and plant hormones (e.g. gibberellins and auxins); nitrogen containing compounds; inorganic compounds; salt binding agents such as gypsum (calcium sulphate); micro-nutrients (such as zinc, copper, boron, and seaweed extracts); botanicals; chitosan; biopolymers; biological agents such as fungi (e.g. mycorrhizal fungi) or bacteria (e.g. beneficial soil bacteria); organic or synthetic fertilizers; biocontrol agents such as pesticides, herbicides, fungicides, insecticides, wool fibres (for deterring slugs); pH-modifiers such as calcium carbonate, lime and sulphur; UV-stabilisers; water absorbing and retaining materials such as silica, bentonite clays; talcum, pigments and colour dyes.
1.22 A method according to any one of Embodiments 1.0 to 1.21 wherein the force adjustment mechanism comprises a spring and a tensioning device for varying the tension in the spring, the spring being oriented such that the tension in the spring either augments or reduces the force applied by the pressing disc to the soil substrate due to the weight of the pressing disc.
1.23 A method according to Embodiment 1.22 wherein the spring is oriented such that the tension in the spring augments the force applied by the pressing disc to the soil substrate due to the weight of the pressing disc.
1.24 A method according to Embodiment 1.22 wherein the spring is oriented such that the tension in the spring reduces the force applied by the pressing disc to the soil substrate due to the weight of the pressing disc.
1.25 A method according to any one of Embodiments 1.0 to 1.24 wherein the pressing disc is mounted on a frame (sub-assembly) which can move up and down thereby reducing or increasing the force applied by the pressing disc to the soil substrate and the force adjustment mechanism is linked to the frame (sub-assembly) and controls or moderates up or down movement of the frame.
1.26. A method according to Embodiment 1.25 wherein the force adjustment mechanism (such as a spring) is arranged to oppose downward movement of the frame, thereby reducing the force applied by the pressing disc to the soil substrate.
1.27 A method according to Embodiment 1.25 wherein the force adjustment mechanism is configured to provide a downwards biassing force to the frame thereby augmenting the force applied by the pressing disc to the soil substrate.
1.28 A method according to Embodiment 1.25 wherein the pressing disc and the cutting disc (when present) are mounted on a sub-assembly which is linked to a main support frame of the carriage by upper and lower arms arranged in a parallelogram configuration, each vertex of the parallelogram constituting a pivot point such that the angles of the parallelogram can be changed; wherein a tensioning element (such as a spring) is disposed between opposing sides and/or vertices of the parallelogram, the tensioning element being adjustable to change the parallelogram configuration to increase or reduce the downforce exerted by the pressing disc on the soil substrate.

In another aspect (Embodiment 2.0), the invention provides an apparatus for use in sowing seeds in a soil substrate, the seeds being carried by a seed tape; wherein the apparatus comprises a carriage provided with a seed tape feeder, and a rotating pressing disc mounted on the carriage; such that, in use:
(i) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the soil substrate as the carriage advances, such that after being pressed into the soil substrate, the longitudinal fold in the seed tape is downwardly oriented and the two edges of the seed tape are upwardly oriented, and there is a vertical gap between the two edges and a surface of the soil substrate;
wherein the apparatus comprises a force adjustment mechanism for the pressing disc to vary the force that can be applied to the soil substrate by the pressing disc and hence vary the depth to which the folded seed tape is pressed into the ground.

The apparatus may comprise a rotating soil cutting disc as hereinbefore defined which may be removable or capable of being lowered or raised to move it towards or away from the soil substrate.

The force adjustment mechanism for the pressing disc may be as defined above in relation to the method aspects of the invention.

In a further aspect (Embodiment 2.1), the invention provides an apparatus for use in sowing seeds in a soil substrate, the seeds being carried by a seed tape; wherein the apparatus comprises a carriage provided with a rotating soil cutting disc, a seed tape feeder, and a rotating pressing disc mounted on the carriage in-line behind the soil cutting disc; such that, in use:
(i) the rotating soil cutting disc cuts a substantially vertical continuous slit as the carriage advances along the soil substrate;
(ii) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the slit as the carriage advances, such that after being pressed into the slit, the longitudinal fold in the seed tape is downwardly oriented and the two edges of the seed tape are upwardly oriented, and there is a vertical gap between the two edges and an upper end of the slit.

Particular and preferred features of the apparatus of the invention correspond to the particular and preferred features of the method of the invention as set out above. Thus, particular embodiments of the apparatus of the invention are as follows:
2.1A An apparatus according to Embodiment 2.1 which comprises a force adjustment mechanism for adjusting a pressing force exerted by the pressing disc against the soil substrate.
2.1B An apparatus according to Embodiment 2.0 or 2.1A wherein the force adjustment mechanism can be used to select a force setting for the pressing disc to provide a desired degree of penetration of the pressing disc into the soil substrate.
2.1C An apparatus according to any one of Embodiments 2.0, 2.1A and 2.1B wherein the force adjustment mechanism comprises a spring and a tensioning device for varying the tension in the spring, the spring being oriented such that the tension in the spring either augments or reduces the force applied by the pressing disc to the soil substrate due to the weight of the pressing disc.
2.1D An apparatus according to Embodiment 2.1C wherein the spring is oriented such that the tension in the spring augments the force applied by the pressing disc to the soil substrate due to the weight of the pressing disc.
2.1E An apparatus according to Embodiment 2.1C wherein the spring is oriented such that the tension in the spring reduces the force applied by the pressing disc to the soil substrate due to the weight of the pressing disc.
2.1F An apparatus according to any one of Embodiments 2.0 and 2.1A to 2.1E wherein the pressing disc is mounted on a frame (sub-assembly) which can move up and down thereby reducing or increasing the force applied by the pressing disc to the soil substrate and the force adjustment mechanism is linked to the frame (sub-assembly) and controls or moderates up or down movement of the frame.
2.1G An apparatus according to Embodiment 2.1F wherein the force adjustment mechanism (such as a spring) is arranged to oppose downward movement of the frame, thereby reducing the force applied by the pressing disc to the soil substrate.
2.1H An apparatus according to Embodiment 2.1F wherein the force adjustment mechanism is configured to provide a downwards biassing force to the frame thereby augmenting the force applied by the pressing disc to the soil substrate.
2.1I An apparatus according to Embodiment 2.1F wherein the pressing disc and the cutting disc (when present) are mounted on a sub-assembly which is linked to a main support frame of the carriage by upper and lower arms arranged in a parallelogram configuration, each vertex of the parallelogram constituting a pivot point such that the angles of the parallelogram can be changed; wherein a tensioning element (such as a spring) is disposed between opposing sides and/or vertices of the parallelogram, the tensioning element being adjustable to change the parallelogram configuration to increase or reduce the downforce exerted by the pressing disc on the soil substrate.
2.2 An apparatus according to Embodiment 2.0 or Embodiment 2.1 wherein the pressing disc is arranged to create a longitudinal fold along a line approximating to the centre line of the seed tape; i.e. its longitudinal axis of symmetry.
2.3 An apparatus according to any one of Embodiments 2.0 to 2.2 wherein the pressing disc is arranged to press the folded seed tape into the slit in the soil substrate (or directly into the soil substrate) such that the uppermost parts of the seed tape (i.e. the two upwardly oriented edges) are below ground level; i.e. there is a vertical gap between the two upwardly oriented edges and an upper end of the slit (or the surface of the soil substrate).
2.4 An apparatus according to any one of Embodiments 2.0 to 2.3 wherein the pressing disc has a surface profile such that during the pressing of the folded seed tape into the slit, an upper end of the slit cut by a cutting disc or formed by the pressing disc is enlarged laterally.
2.5 An apparatus according to Embodiment 2.4 wherein the surface profile of the pressing disc comprises a shoulder on one or both sides of the pressing disc, which shoulder (i) where a slit is initially formed, comes into contact with the upper end of the slit during the pressing, thereby to enlarge the upper end of the slit laterally; or (ii) where no slit is initially formed by a cutting disc, creates an enlarged region or channel above the folded seed tape after it has been pressed into the soil substrate.
2.6 An apparatus according to Embodiment 2.5 wherein each shoulder is sloped or curved.
2.7 An apparatus according to Embodiment 2.6 wherein sloped shoulders are present on both sides of the pressing disc and are configured to create a substantially V-shaped enlarged region at the upper end of the slit or the enlarged region or channel.
2.8 An apparatus according to any one of Embodiments 2.5 to 2.7 wherein the shoulders are formed integrally with the pressing disc.
2.9 An apparatus according to any one of Embodiments 2.5 to 2.7 wherein the shoulders are formed integrally and are secured to the pressing disc.
2.10 An apparatus according to Embodiment 2.9 wherein the shoulders are formed from a plastics material.
2.11 An apparatus according to any one of Embodiments 2.5 to 2.10 wherein there is a radial spacing between the shoulder(s) and the peripheral pressing edge of the pressing disc which is at least 1 cm in size.
2.12 An apparatus according to Embodiment 2.11 wherein the radial spacing is at least 1.5 cm in size, for example from 1.7 cm to 2 cm.
2.13 An apparatus according to any one of Embodiments 2.1 to 2.12 wherein an adjustable height mechanism is provided on the carriage for varying the height of the pressing disc above the soil substrate.
2.14 An apparatus according to any one of Embodiments 2.1 to 2.13 wherein the soil cutting disc when present is arranged to cut a slit of from 5-20 cm deep.
2.15 An apparatus according to Embodiment 2.14 wherein the soil cutting disc is arranged to cut a slit of from 5-10 cm deep.
2.15A An apparatus according to any one of Embodiments 2.0 to 2.15 further comprising one or more support wheels (or “jockey wheels”) to support the apparatus on the underlying substrate/soil.
2.16 An apparatus according to any one of Embodiments 2.0 to 2.15 wherein the seed tape feeder comprises a roll of the seed tape and one or more guide rollers for guiding the seed tape into place.
2.17 An apparatus according to Embodiment 2.16 wherein the one or more guide rollers are positioned such that the seed tape is brought into contact with the pressing disc at a point approximately at the top of the slit, when present.
2.18 An apparatus according to Embodiment 2.16 wherein the one or more guide rollers are positioned such that the seed tape is brought into contact with the pressing disc at a point above the top of the slit, when present.
2.19 An apparatus according to Embodiment 2.16 wherein the one or more guide rollers are arranged to lay the seed tape on top of the soil substrate over the slit, when present, prior to contact with the pressing disc.
2.19A An apparatus according to Embodiment 2.16 wherein the seed tape roll is oriented so that it initially unwinds in a lateral direction and a turn roller is provided to change a direction of travel of the seed tape so that it is in-line with the pressing disc.
2.19B An apparatus according to Embodiment 2.19A wherein the seed tape roll rotates about an axis at an angle of about 90° relative to the axis of rotation of the pressing disc.
2.20 An apparatus according to any one of Embodiments 2.1 to 2.19B wherein the seed tape comprises a polymer film layer having a plurality of seeds at least partially embedded therein, and a porous reinforcing layer bonded to the polymer film layer.
2.21 An apparatus according to Embodiment 2.20 wherein the seed tape feeder is arranged to deliver the seed tape such that, when the seed tape is folded, the porous reinforcing layer preferably constitutes the inner surface of the folded seed tape so that the seed-containing polymer layer faces outwards.
2.22 An apparatus according to any one of Embodiments 2.1 to 2.21 wherein the seed tape prior to folding has width in the range from about 3 cm to 8 cm, for example from about 3.5 cm to about 5.5 cm.
2.23 An apparatus according to Embodiment 2.22 wherein the seed tape prior to folding has a thickness (disregarding the size of any seeds adhered to the tapes but including any coatings on a carrier) of from about 0.5 mm to about 5 mm, more typically from 0.6-1 mm.
2.24 An apparatus according to any one of Embodiments 2.1 to 2.23 wherein the seed tapes contain one or more active ingredients for enhancing the germination or growth of plants from the seeds, or for controlling or eradicating pests.
2.25 An apparatus according to Embodiment 2.24 wherein the seed tapes contain one or more active ingredients selected from plant growth additives; soil-adjustment additives; extender and/or seed protection additives; bio-stimulants such as humic acid, fulvic acid and plant hormones (e.g. gibberellins and auxins); nitrogen containing compounds; inorganic compounds; salt binding agents such as gypsum (calcium sulphate); micro-nutrients (such as zinc, copper, boron, and seaweed extracts); botanicals; chitosan; biopolymers; biological agents such as fungi (e.g. mycorrhizal fungi) or bacteria (e.g. beneficial soil bacteria); organic or synthetic fertilizers; biocontrol agents such as pesticides, herbicides, fungicides, insecticides, wool fibres (for deterring slugs); pH-modifiers such as calcium carbonate, lime and sulphur; UV-stabilisers; water absorbing and retaining materials such as silica, bentonite clays; talcum; pigments and colour dyes.

Further aspects and embodiments of the invention will be apparent from the specific description below and the accompanying drawings.

### BRIEF DESCRIPTION OF THE DRAWING

FIG. 1 is a schematic illustration of the key components of an apparatus according to one embodiment of the invention. The supporting structure on which the key components are mounted has been omitted for visual clarity. FIG. 1 contains some exemplary dimensions but these are not intended to be limiting.

FIG. 2 is a schematic illustration showing the relative depths of penetration of the soil cutting disc and pressing disc into the soil substrate.

FIG. 3 is a photograph showing the soil cutting disc cutting a slit in the soil substrate.

FIG. 4 is a photograph showing the pressing disc.

FIG. 5 is a schematic view showing the germination of a seedling from a seed tape installed in a slit according to the invention.

FIG. 6 is a photograph showing seedlings growing from the seed tape.

FIG. 7 is a perspective view from one side showing an apparatus according to a second embodiment of the invention. The apparatus of this embodiment can be used to install four seed tapes in parallel but, for clarity, only one of the four seed tape feeders is shown.

FIG. 8 is a perspective view from another side of the apparatus of FIG. 8.

FIG. 9 is a view from above of the apparatus of FIGS. 8 and 9.

FIG. 10 is a photographic view showing part of a seed tape feeding mechanism in an apparatus according to a third embodiment of the invention.

FIG. 11 is a photographic view of the apparatus of FIG. 10 but with the upper part of the apparatus not shown.

FIG. 12 is a side view of the pressing disc/cutting disc sub-assembly of the apparatus of FIGS. 10 and 11. In this view, the force adjustment mechanism is configured to be adjustable so that the downforce of the pressing disc is reduced.

FIG. 13 is a side view of the pressing disc/cutting disc sub-assembly of the apparatus of FIGS. 10 and 11 but, in this view, the force adjustment mechanism is configured to be adjustable so that the downforce of the pressing disc is increased.

FIG. 14 is a perspective view of the sub-assembly shown in FIGS. 12 and 13 but with several elements omitted for clarity.

FIG. 15 is a schematic cross-sectional view of a seed tape after folding by an apparatus as shown in any of FIGS. 1 to 14, wherein possible alternative locations of rows of seeds are indicated.

FIG. 16 is a schematic cross-sectional view of the seed tape of FIG. 15 planted in a vertical slit in the ground.

FIG. 17 is a schematic cross-sectional view showing a lower part of the edge of a pressing disc and seed tape embedded in the ground.

FIG. 18 is an enlarged view of part of FIG. 17.

### DETAILED DESCRIPTION OF EMBODIMENTS OF THE INVENTION

Embodiments of the method and apparatus of the invention will now be described in more detail with reference to the accompanying drawings.

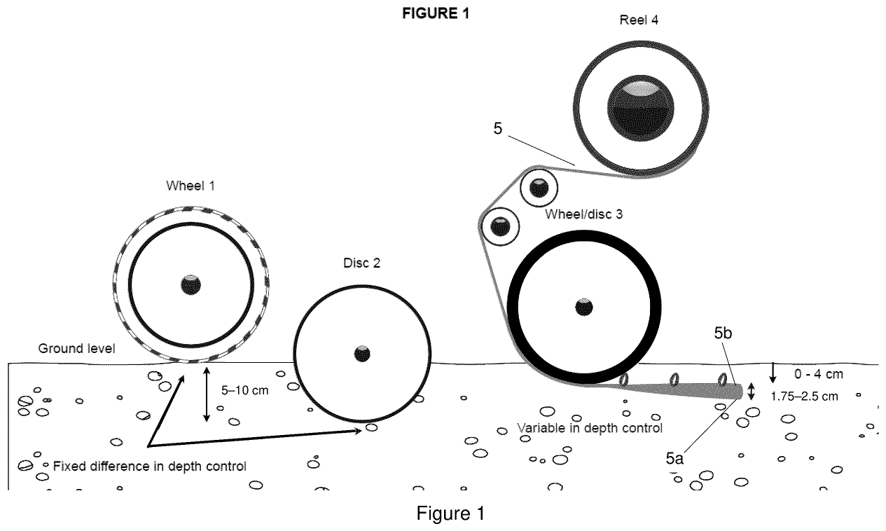

An apparatus according to one embodiment of the invention is shown schematically in FIG. 1 and comprises a carriage of a type that can be towed behind a tractor. The carriage comprises a support frame which has been omitted for clarity in FIG. 1. One wheel, jockey wheel (1), is shown as resting on the underlying soil substrate, for example a field. It will be appreciated that in some conditions (for example for use on harder soils), the jockey wheel may be dispensed with.

Rotatably mounted on the support frame behind the jockey wheel (1) is a soil cutting disc (2) which is typically formed from steel. Mounted on the support frame in line with and behind the soil cutting disc (2) is pressing disc (3). A seed tape feeder comprising a rotating roll (4) of seed tape and a pair of guide rollers are each rotatably mounted on the support frame. As shown in FIG. 1, the seed tape feeder delivers the seed tape into the path of the pressing disc (3).

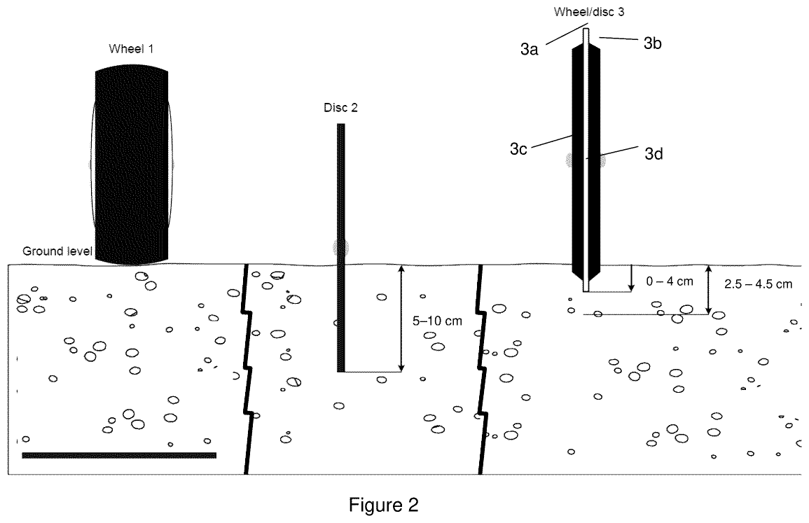

The profiles of the soil cutting disc (2) and pressing disc (3) are shown in FIG. 2, alongside a jockey wheel (1). The soil cutting disc (2) has a relatively narrow soil cutting edge for cutting a slit in the underlying soil substrate. By contrast, the pressing disc (3) has a narrow peripheral pressing edge (3a) and an angled annular shoulder (3b) on each side of the disc. The annular shoulders (3b) are formed on plastics discs (3c) which are manufactured separately and are secured to a main body (3d) of the disc which is formed from a metal material such as steel.

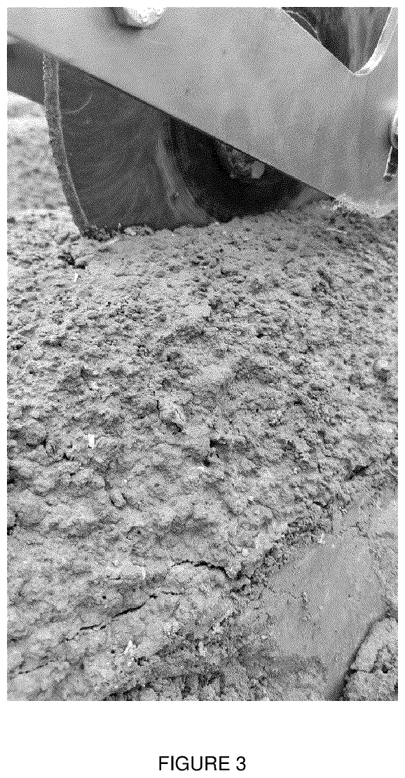

FIG. 3 shows the soil cutting disc (2) in close-up together with a part of the support frame on which the cutting disc (2) is attached. In FIG. 3, the relatively narrow edge of the disc (2) is clearly visible. The soil cutting disc (2) is typically mounted on the support frame such that there is a fixed distance between the lower surface of the jockey wheel (1) and the lower surface of the cutting disc (2). This ensures that the slit cut in the soil substrate is of consistent depth. The depth of the slit may be, for example, from about 5 cm to 15 cm, and more usually from about 5 cm to about 10 cm.

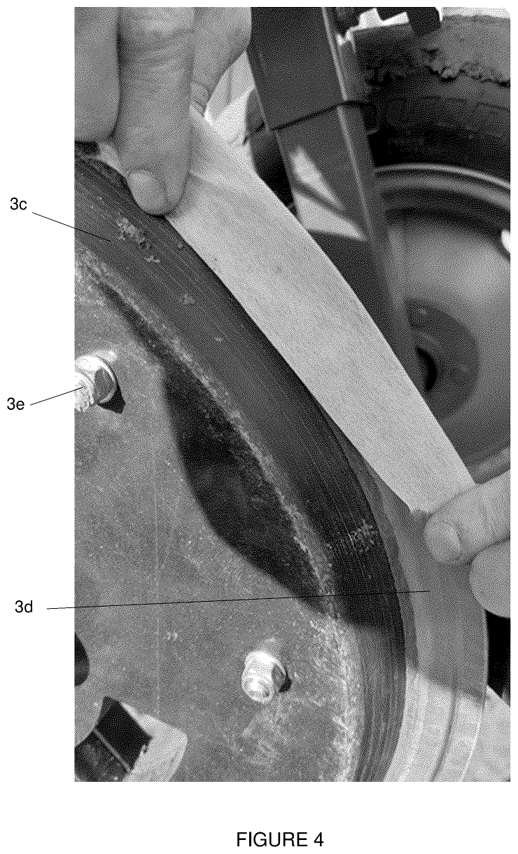

FIG. 4 shows the pressing disc (3) in close-up. The plastic discs (3c) are secured to the main body (3d) of the pressing disc by means of nuts and bolts (3e). For illustration purposes to demonstrate typical relative dimensions, FIG. 4 shows a length of the seed tape being held manually against the peripheral pressing edge of the pressing disc (3). Also shown in FIG. 4 is a part of the support frame on which the pressing disc (3) is mounted. The pressing disc (3) can be mounted in such a way that the force applied by the pressing disc (3) can be adjusted thereby allowing variation of the depth to which the seed tape can be pressed into the slit. This allows seeds to be placed very accurately at a desired depth in the soil which is optimal for the plant species or variety in question. The force adjustment mechanism is described in more detail below.

In use, the carriage is advanced along a field or other soil substrate and soil cutting disc (2) cuts a continuous longitudinally extending slit in the soil substrate. The seed tape (5) is unwound from the reel (4) and rollers and, prior to contact with the pressing disc, is at 90° with respect to the plane of the pressing disc. The seed tape (5) from the reel (4) is delivered into the path of the pressing disc (3) and, as it contacts the peripheral pressing edge of the pressing disc (3), wraps around the edge and is folded in half. The peripheral pressing edge then pushes the folded seed tape (5) down into the slit so that the fold (5a) faces downwards a (6) and the two lateral edges (5b) of the folded seed strip face upwards.

The pressing disc continues to press the folded seed tape (1) into the slit so that the angled shoulders (6a) push against the soil and form an enlarged generally V-shaped region or channel at the top of the slit.

The combination of the relatively blunt peripheral pressing edge of the pressing disc (3) and the tensile strength of the seed tape (5) ensures that the edge does not tear the seed tape (5) as the seed tape is pressed into the slit.

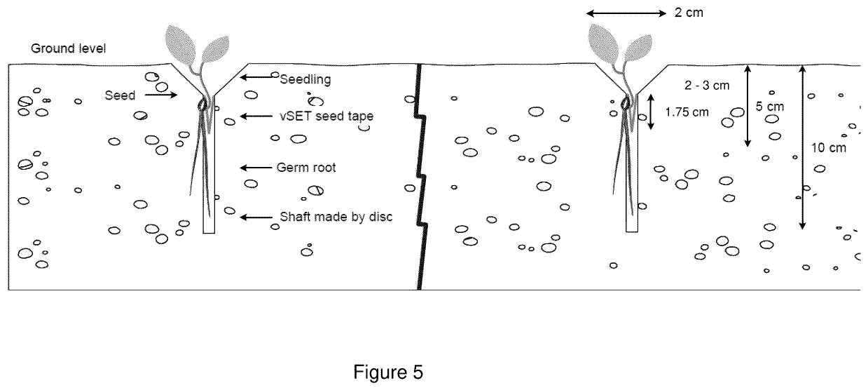

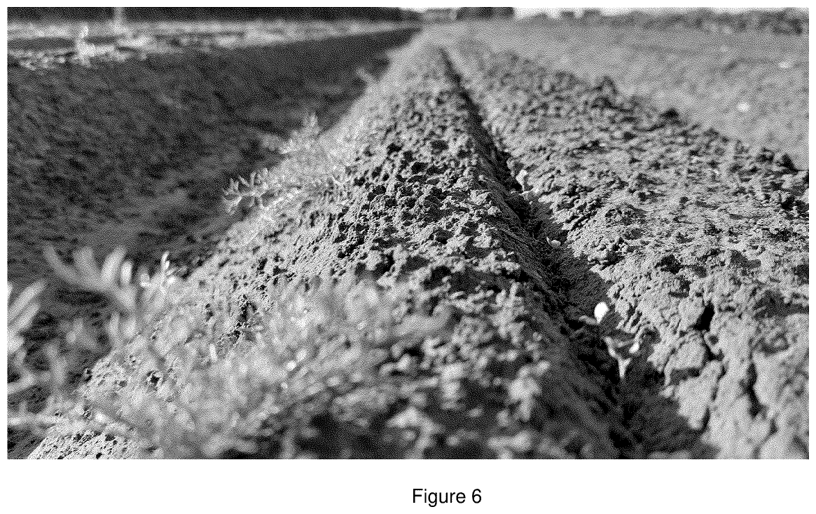

The cross-sectional profile of the slit after the folded seed tape has been pressed into the slit is shown in FIGS. 5 and 6. FIG. 5 also shows seedlings developing from germinated seeds. The gap beneath the folded seed tape provides space into which the roots of the seedling can grow without resistance. The enlarged V-shaped cross section space above the folded ribbon provides room for the stems and leaves of the seedlings to grow before they emerge above ground, as shown in FIG. 6. Thus, by positioning the seed tape below the surface of the ground and providing an enlarged upper region of the slit in which the seedlings can grow, the seedlings are provided with protection against environmental conditions such as wind which might otherwise damage the seedlings. The V-shaped profile also serves to funnel water from rain or irrigation sources into the slit thereby making more optimal use of water supplies. The absorbent material from which the seed tape (5) is made means that the seed tape can absorb water, from rainwater, or irrigation or from the surrounding soil and therefore provide a constant supply of moisture to the seedlings.

The angle of the V-shape may be varied according to the type of soil in which the seeds are to be planted. For example, in relatively sandy soils, a wider angle V-shape than shown in the Figures may be used to prevent the walls of the V-shape profile from collapsing.

In the arrangement shown in FIG. 5, the germinated seedlings emerge from the outer surface of the folded seed tape rather than growing down through the fold from the inner surface of the folded seed tape. In one embodiment of the invention, the seed tape can be of the type described in International patent application number PCT/EP/2020/059291 (WO2020/201373) and can comprise a polymer film layer having seeds at least partially embedded therein, and a porous reinforcing layer bonded to the polymer film layer. In this embodiment, when the seed tape is folded, the porous reinforcing layer constitutes the inner surface of the folded ribbon so that the seed-containing film layer faces outwards. This ensures that the polymer film layer is in direct contact with the soil, allowing water to be more easily circulated from the soil to the seeds with reduced competition for water from the porous reinforcing layer. The porous reinforcing layer will absorb water and, when saturated, will act as a water reservoir for the seedlings as they germinate. By folding the seed tape (5) so that the porous reinforcing layer is on the inside and the polymer film layer containing the seeds is on the outside, the roots of the seedling do not need to grow through the porous reinforcing layer and therefore resistance to root growth is minimised.

The seeds can be located towards the edges of the seed tape so that the centre of the seed tape contains no seeds. One advantage of this arrangement is that the seeds are closer to the surface and, are in a better position to start early plant growth, and seedlings germinated from the seeds are likely to emerge above ground at around the same time, rather than over a more prolonged period which could be the case if the seeds are distributed across the width of the seed tape rather than at the edges. A further advantage of placing the seeds at the edges of the seed tape and leaving the centre of the seed tape relatively free of seeds is that there is a much smaller likelihood of the seeds being crushed by the pressing disc as the seed tape is pressed into the ground.

In addition to the protection afforded to germinating seeds and developing seedlings by the present invention, a further advantage of the present invention over known methods of seeding using seed strips is that once the slit has been cut and the seed tape installed in the slit, no further disturbance of the soil is necessary. In particular, it is not necessary to cover the seed tape with soil in order to anchor the seed strips in place as is the case with seed strips that are laid flat onto the ground or in a shallow furrow.

Another benefit of the present invention is that the seed tape protects the pressing disc (3) from clogging with mud or soil when soil conditions are wet. Therefore, in contrast to many planting methods, where the risk of machinery clogging with mud means that they tend not to be used when soil conditions are wet, the method and apparatus of the present invention can be used in a wider range of soil conditions and therefore provides a greater window of opportunity for planting.

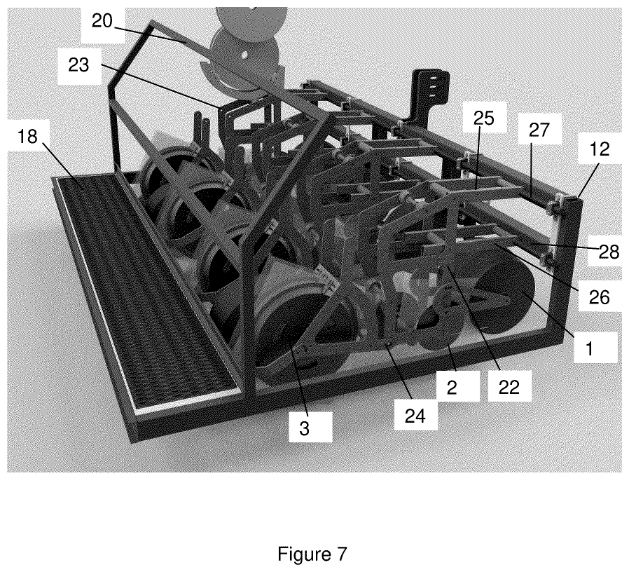

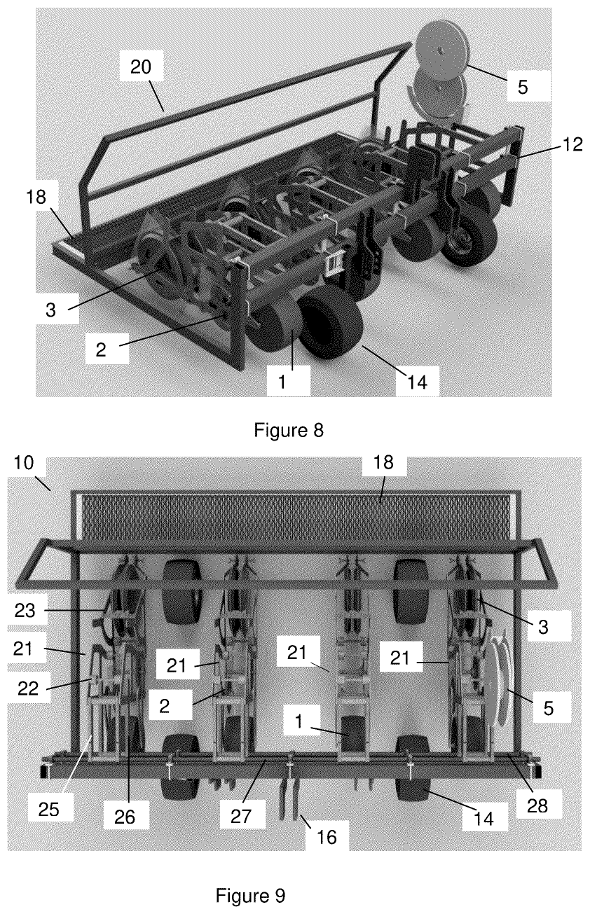

FIGS. 7 to 9 illustrate an apparatus according to a second embodiment of the invention. The apparatus is similar to the apparatus of FIGS. 1 to 6 and takes the form of a carriage (10) comprising a support frame (12) mounted on four wheels (14). The frame also has mounted thereon four parallel sets of variable height jockey wheels (1), soil cutting discs (2), pressing discs (3) and seed tape reels (5). Only one of the four sets of seed tape reels is shown in the Figures and the guide rollers have also been omitted. At the front of the carriage (10) is a towing hitch (16) for attaching the carriage to a tractor. At the rear of the carriage is a footplate (18) for upon which an operative (e.g. farm worker) can stand as the carriage is being towed along. A handrail (20) is provided for an operative standing on the footplate (18) to hold on to. In order to reduce the weight of the apparatus and minimize rutting of the soil, the footplate (18) and handrail (20) may be omitted.

Mounted on the support frame (12) of the carriage are a series of sub-frame assemblies (21) (four in total in this embodiment), each of which has mounted thereon a jockey wheel (1), soil cutting disc (2) and pressing disc (3). Each sub-frame assembly comprises a forward mounting frame (22) and a rear mounting frame (23), the terms “forward” and “rear” as used herein referring to the direction of travel of the carriage in use. Rotatably attached at the lower end of the forward mounting frame (22) are the cutting disc (2) and the jockey wheel (1). The pressing disc (3) is rotatably mounted on the rear mounting frame. The rear mounting frame (23) is attached to the lower part of the forward mounting frame (22) at a pivot point (24). The rear mounting frame (23) is restrained against pivoting about the pivot point (24) by a threaded adjustment rod (not shown) connecting the upper parts of the forward (22) and rear (23) mounting frames. The threaded adjustment rod enables the angle between the forward (22) and rear (23) mounting frames to be adjusted and provides one means of adjusting the force applied by the pressing disc (3) to the underlying soil substrate. The sub-frame assemblies (21) are attached to the support frame (12) of the carriage by pairs of parallel connecting arms (25, 26). All four connecting arms are each pivotably connected at one end to the forward mounting frame (22) and at their other end to a transverse rod (27, 28). Together, the connecting arms (25, 26), the forward edge of the forward mounting frame (22) and the pivot points on the transverse rods (27, 28) form a parallelogram/rhomboid configuration.

In the drawings, the connecting arms (25, 26), the forward edge of the forward mounting frame (22) and the pivot points on the transverse rods (27, 28) are shown in a rectangular parallelogram configuration. However, by moving the forward mounting frame (22) up and down, the configuration will change from rectangular parallelogram to rhomboid parallelogram and vice versa. Note that the term “rhomboid” as used herein includes the particular case of a rhombus where all four sides are of equal length, as well as configurations of a true rhomboid shape where there are two pairs of sides of unequal length. Similarly, the term “rectangular parallelogram” includes the case where all side are of equal length (i.e. a square configuration) as well as configurations where adjacent sides are of unequal length.

The ability of the forward mounting frame to move up and down provides a means of adjusting the force applied by the pressing disc (3) to the underlying soil substrate and hence the depth (penetration depth) to which the seed tape is pushed into the soil. The force applied by the pressing disc (3) can be controlled by using a spring tensioner (not shown) mounted approximately between diagonally opposing corners of the parallelogram. If connected approximately diagonally between the upper pivot point on the mounting frame (22) (i.e. the pivot point to which the upper arm (25) is connected) and the pivot point on the lower transverse rod (28), the spring tensioner can be set to bias the mounting frame (22) in a downwards direction thereby increasing the force applied by the pressing disc. Conversely, if a spring tensioner is connected in the opposite diagonal direction, i.e. between the lower pivot point on the mounting frame (22) where the lower arm (26) is connected, and the pivot point on the upper transverse rod (27), the spring tensioner can be set to bias the mounting frame (22) in an upwards direction thereby reducing the force applied by the pressing disc.

The orientations of the spring tensioners and the degree of tension applied to the springs will be usually selected according to the soil type. For example, the apparatus may be provided with “factory settings” where the connecting arms (25, 26), the forward edge of the forward mounting frame (22) and the pivot points on the transverse rods (27, 28) are in a rectangular parallelogram configuration and the weight, diameter and profile of the pressing disc are such as to create a desired penetration depth in “normal” or “average” soils, e.g. the most commonly encountered soil types and conditions. If the soil is a lighter-than-average soil, the spring tensioner is oriented and tensioned so as to lift the mounting frame (22) and thereby reduce the downforce of the pressing disc (3). This prevents the pressing disc (3) from sinking into the soil too deeply and allows the pressing to follow the contours of the ground more easily. Conversely, if the soil type Is heavier than average, the spring tensioner orientation and spring tension can be set so as to increase the downforce of the pressing disc (3) on the soil. Alternatively, the “factory settings” could be such that the connecting arms (25, 26), the forward edge of the forward mounting frame (22) and the pivot points on the transverse rods (27, 28) are in a rhomboid parallelogram configuration.

It will be appreciated that the spring tensioner could comprise a mechanical spring and tension adjustment mechanism, but it could alternatively comprise a gas spring or hydraulic spring and a suitable tension adjustment mechanism or indeed another type of force regulator system. Although mechanical actuators (e.g. electronically controlled) could be used in place of spring tensioners, an advantage of using spring tensioners is that they allow the apparatus to absorb undulating movement caused by uneven ground.

The apparatuses of FIGS. 1 to 9 each have a cutting disc to cut a slit in the soil substrate and a pressing disc to press the folded seed tape into the ground, However, it has been found that in certain conditions, when the ground is softer, the seed tape can be pressed into the ground without the need for a slit to be cut first. Thus, in such circumstances, an apparatus can be used in which either there is no cutting disc, or there is a cutting disc, but it is capable of being moved out of contact with the ground (e.g. by being raised).

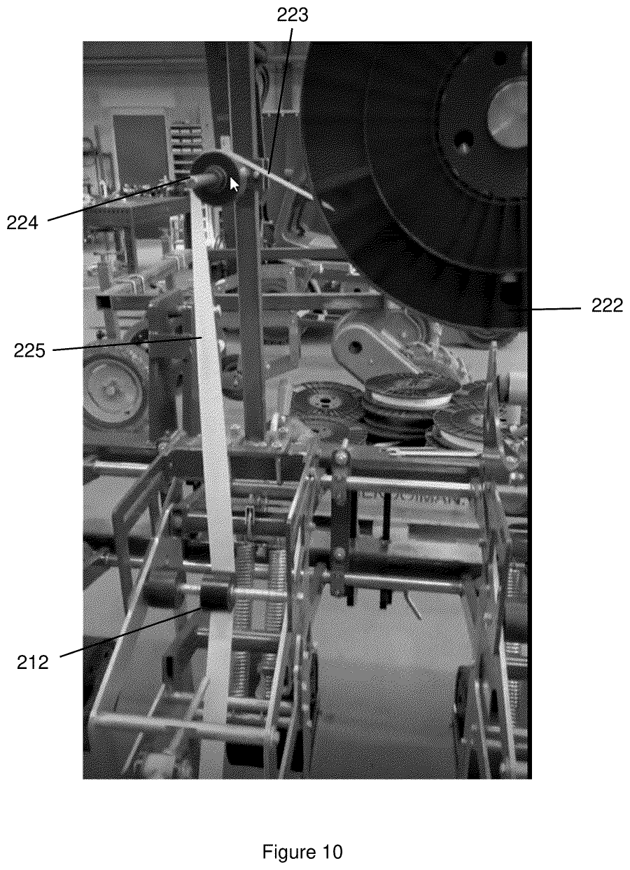

In the apparatus shown in FIGS. 7 to 9, the seed tape reels rotate about axes parallel to the axes of rotation of the cutting and pressing discs and are therefore in-line with the pressing discs. In the apparatus of FIG. 10, an alternative arrangement is provided in which the seed tape reels rotate about an axis which is at a right angle to the axes of rotation of the pressing discs.

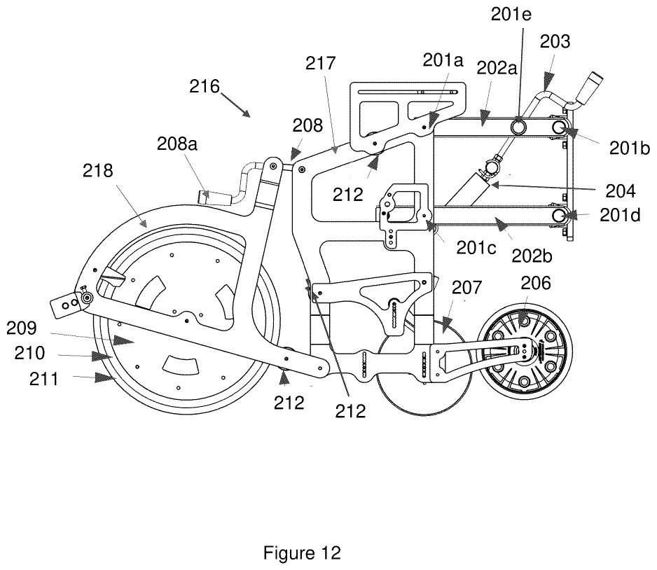

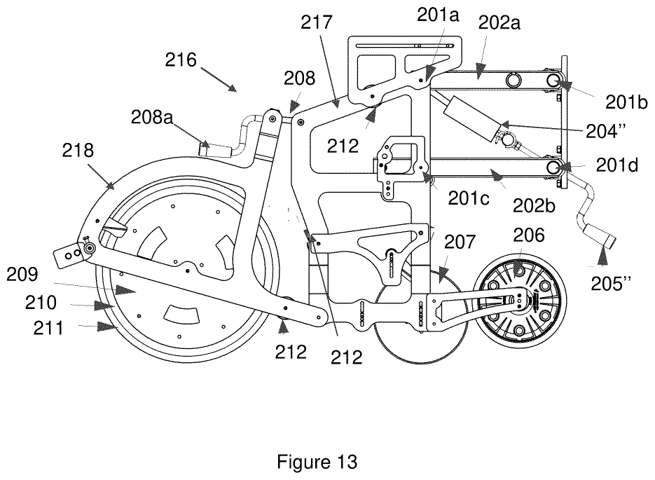

Thus, as shown in FIG. 10, the seed tape (225) is dispensed from a seed tape reel (222) which is mounted for rotation about an axis which is oriented at an angle of approximately 90° to the axis of the pressing disc. After it emerges from the tape reel (222), the direction of travel of the seed tape (225) is turned through approximately 90° by the turn roller (224), from which it is directed on to guide roller (212) and then via further guide rollers (212) (see FIGS. 12 and 13) to the pressing disc (209) (not shown in FIG. 10). It has been found that by initially unwinding the seed tape laterally with respect to the direction of travel of the apparatus and then turning it through 90° so that it is then in-line with the pressing disc, more accurate placement of the centre of the seed tape against the pressing disc is obtained. This is believed to be due to better control of the tension in the seed tape and minimizing the extent of sideways drift of the seed tape as it moves along its path to the pressing disc.

The turn roller (224) has a concave profile to assist in centering the seed tape, although the precise shape of the turn roller is not critical. The guide rollers (212) may also have a slight concave profile although this is not essential.

In addition to the advantage of the more accurate placement of the centre of the seed tape on the pressing disc provided by the seed tape reel and turn roller arrangement shown in FIG. 10, a further advantage is that the seed tape reel can be mounted closer to the edge of the carriage and it therefore easier to access for removal and replacement.

Although the seed tape reel is mounted at an angle of 90° with respect to the axis of the pressing disc, it could instead be mounted at an angle of between 45° and 90°.

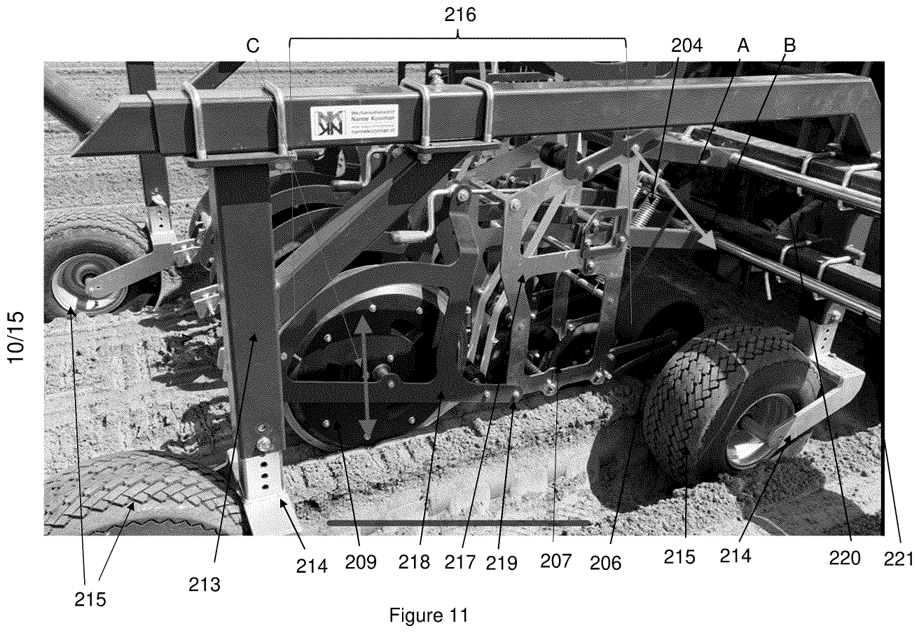

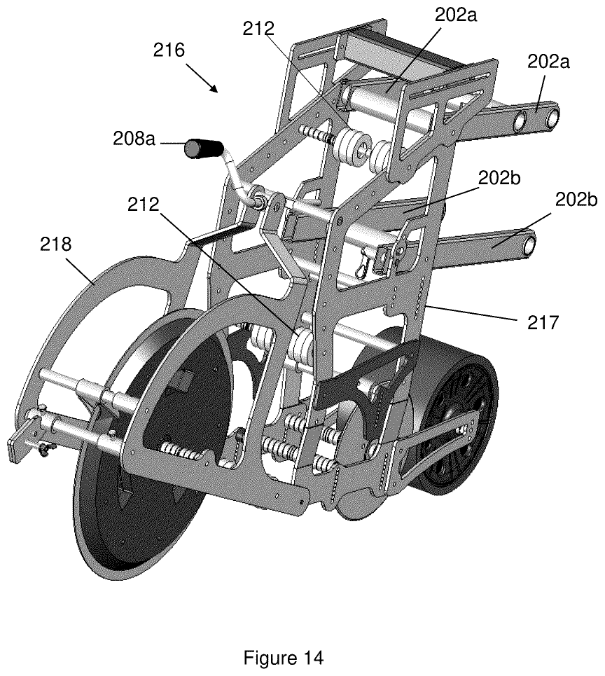

FIG. 11 shows the lower part of the apparatus of FIG. 10, with the seed tape dispenser not shown. FIG. 12 is a side view of a sub-assembly forming part of the apparatus of FIG. 10 and FIG. 14 is a perspective view of the sub-assembly of FIG. 12 but with several parts omitted for clarity.

The apparatus of this third embodiment of the invention is similar to the apparatus of FIGS. 1 to 9 and takes the form of a carriage comprising a support frame (213) having four adjustable height wheel mountings (214) on which are mounted on four wheels (215).

Mounted on the support frame (213) of the carriage are a series of sub-assemblies (216) (three in total in this embodiment) each sub-assembly comprising a forward mounting frame (217) and a rear mounting frame (218), the terms “forward” and “rear” as used herein referring to the direction of travel of the carriage in use. Rotatably attached at the lower end of the forward mounting frame (217) are a cutting disc (207) and a jockey wheel (206). A pressing disc (209) is rotatably mounted on the rear mounting frame (218). The rear mounting frame (218) is attached to the lower part of the forward mounting frame (217) at a pivot point (219). The rear mounting frame (218) is restrained against pivoting about the pivot point (219) by a threaded adjustment rod (208) connecting the upper parts of the forward (217) and rear (218) mounting frames. The rotatable handle (208a) on the threaded adjustment rod (208) enables the angle between the forward (217) and rear (218) mounting frames to be adjusted and provides one means of adjusting the force applied by the pressing disc (209) to the underlying soil substrate.

The sub-assemblies (216) are attached to the support frame (213) of the carriage by pairs of parallel connecting arms (202a, 202b). The top pair of arms (202a) are each pivotably connected at one end to a pair of pivot points (201a) on the forward mounting frame (217) and at their other end to a pair of pivot points (201b) on a transverse rod (220). The bottom pair of connecting arms (202b) are each pivotably connected at one end to a pair of pivot points (201c) on the forward mounting frame (217) and at their other end to a pair of pivot points (201d) on a transverse rod (221). Together, the connecting arms (202a, 202b), the forward edge of the forward mounting frame (217) and the pivot points (201a, 201b, 201c, 201d) on the transverse rods (220, 221) form a parallelogram configuration.

In FIG. 12, the connecting arms (202a, 202b), the forward edge of the forward mounting frame (217) and the pivot points (201) on the transverse rods (220, 221) are shown in a rectangular parallelogram configuration. However, by moving the forward mounting frame (217) up and down, the configuration will change from rectangular parallelogram to rhomboid parallelogram and vice versa as described above in relation to the apparatus shown in FIGS. 7 to 9.

The force applied by the pressing disc (209) to the underlying soil substrate and hence the depth to which the seed tape is pushed into the soil can be controlled by using a spring tensioner (204) extending generally diagonally across the parallelogram as shown in FIG. 12. In this embodiment, the spring tensioner extends between a crossbar between pivot points (201c) in a generally diagonal direction to a crossbar between a pair of pivot points (201e) on the pair of upper arms (202a). Tightening the tensioner (204) using the adjustment handle (203) to increase the tension in the spring has the effect of pulling the pivot points 201c and (201b/d) thereby lifting the mounting frame (2017). Thus, in this configuration, the spring tensioner is set to bias the mounting frame (217) in an upwards direction thereby reducing the force applied by the pressing disc (209). The direction of bias of the spring tensioner is indicated by arrow A in FIG. 11. Analogously to the embodiment of FIGS. 7 to 9 described above, this setting would typically be used for lighter (e.g. sandier) soils.

FIG. 13 shows a sub-assembly identical to that shown in FIG. 12 except that, in this embodiment, the orientation of the spring tensioner (204″) differs from the orientation of the spring tensioner (204) in FIG. 12. In the apparatus of FIG. 13, the spring tensioner (204″) extends in a generally opposite diagonal direction from a crossbar between a pair of pivot points (201a) on the forward mounting frame (217) to a crossbar between a pair of pivot points (201d) linking the pair of lower arms (221) to the transverse rod (221). Tightening the spring tensioner (204″) using the adjustment handle (205) to increase the spring tension has the effect of drawing the opposing pivot points (201a) and (201d) together such that the forward mounting frame (217) is pulled downwards. Thus, in this configuration, the spring tensioner is set to bias the mounting frame (217) in a downwards direction thereby increasing the force applied by the pressing disc (209). The direction of bias of the spring tensioner is indicated by arrow B in FIG. 11. This setting would typically be used for heavier soils or soils covered by the remnants of previous crops.

For “normal” or “average” soils, the spring tensioners are set such that no significant additional upwards or downwards force is created and the arms (202a) and (202b) remain substantially horizontal, i.e. in a rectangular parallelogram configuration. In this configuration, the downforce exerted by the pressing wheel (209) and the penetration depth into the soil, are determined by the weight, diameter and profile of the pressing wheel (209). This condition is indicated by the double headed arrow C in FIG. 11. However, it will be appreciated that instead of the rectangular parallelogram configuration, the setting for “normal” or “average” soils could be a rhomboid parallelogram configuration.

In embodiments illustrated in FIGS. 7 to 13, the apparatus has a jockey wheel (1, 206) associated with each pressing disc and cutting disc. However, the jockey wheel is not essential and will generally only be used on extremely soft soils. For harder soils, undulations and bumps in the ground may cause the jockey wheel to lift the pressing wheel away from the ground. If the jockey wheel is used, the screw adjuster (208) can be used to adjust the impression depth of the pressing wheel (209) in relation to the jockey wheel (206).

The seed tape is guided by the guide rollers (212) to the pressing wheel and is then pressed into the underlying soil substrate, either directly by the pressing wheel or after a cutting wheel (207), if present, has first cut a slit in the ground.

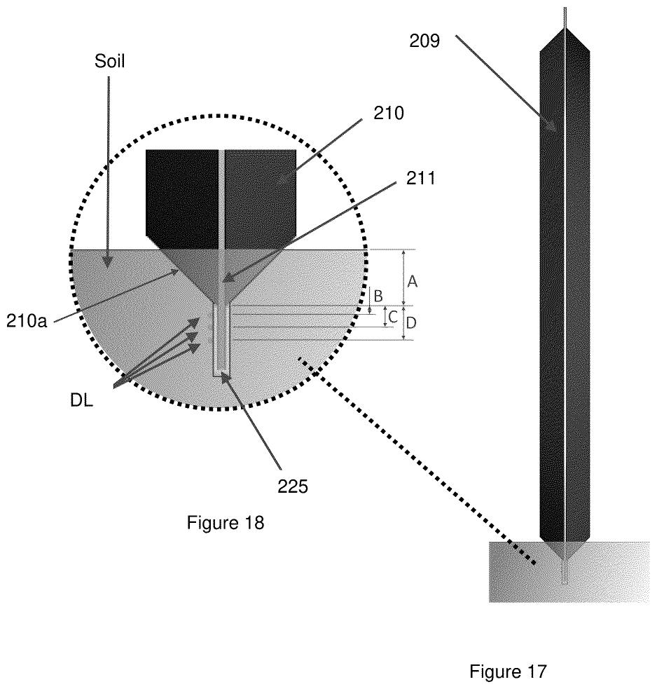

A typical profile of the pressing disc (209) of the apparatus of FIGS. 10 to 13 is shown in FIGS. 17 and 18. Thus, in this embodiment, the pressing disc comprises a relatively narrow metal (e.g. steel) disc (211) sandwiched between two discs (210) formed of a suitably tough plastics material and having inclined shoulders (210a). The plastic discs can be attached to the metal disc (211) by various means such as rivets or, to facilitate replacement, screws or nuts and bolts.

FIG. 18 is an enlarged view showing the pressing disc (209) pressed into the soil with the seed tape (225) wrapped around the edge of the metal disc (211). The metal disc (211) presses the seed tape (225) into the ground (or into a slit cut by the cutting disc (207) when present) whereas the angled shoulders (210a) on the plastics discs widen out the upper part of the slit created by the metal disc (211) and/or the cutting disc (207).

The depth to which the seed tape is pressed into the ground is dependent on the configuration of the pressing disc (209) and the downforce exerted by the pressing disc. However, in the embodiments of FIGS. 7 to 18, the depth to which the seeds are planted is determined by the positioning of the seeds on the seed tape during its manufacture.

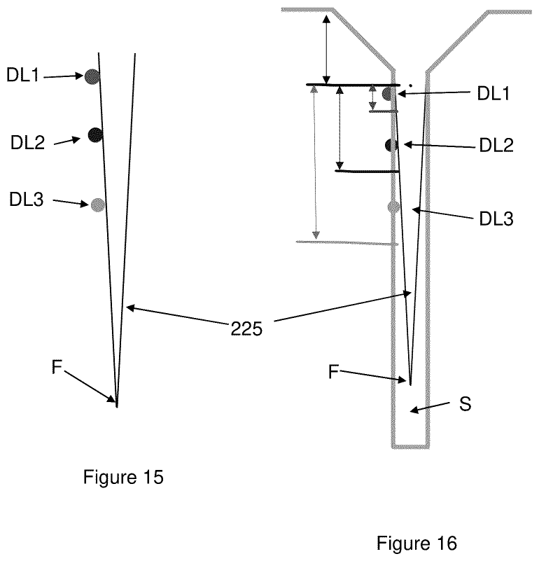

FIG. 15 shows a folded seed tape (225) in which three possible locations (DL1, DL2, DL3) for the attachment of a row of seeds are shown. Usually, a seed tape will have bonded thereto a row of seeds at one distance (e.g. DL1) from the edge of the seed tape. The row of seeds is parallel to but spaced apart from the fold F in the seed tape. In order to ensure efficient germination without being impeded by any reinforcing layer in the seed tape, the seeds are bonded to (or embedded in) the side of the seed tape which will face outwardly when the seed tape is in the ground. The distance between the row of seeds and edge of the seed tape will determine the depth of the seed when it is planted. Thus, the row of seeds at distance DL1 from the edge of the seed tape will be closest to the surface while the row of seeds at distance DL3 will be furthest from the surface. The rows of seeds can be positioned on the seed tape with great precision during manufacture. Thus, the depth to which the seed tape in pressed into the ground can be controlled very accurately during planting and the position of the rows of seeds on the seed tape can be controlled very accurately during manufacture of the seed tapes. Taken together, these two factors in combination mean that planting seeds at a desired seed density and seed depth can be accomplished very accurately using the methods and apparatus of the invention.

### Equivalents

The embodiment described above and illustrated in the accompanying drawings is merely illustrative of the invention and is not intended to have any limiting effect. It will readily be apparent that numerous modifications and alterations may be made to the specific embodiment shown without departing from the principles underlying the invention. All such modifications and alterations are intended to be embraced by this application, for example as defined by the claims herein.

For the avoidance of doubt, it is note that any reference numerals in the claims should not be construed as limiting the scope of the invention.

1. A method for sowing seeds in a soil substrate, the seeds being carried by a seed tape; which method comprises
feeding the seed tape in front of a pressing disc and bringing the seed tape into contact with the pressing disc so that a peripheral pressing edge of the pressing disc is substantially centrally aligned between two edges of the seed tape;
advancing the pressing disc along a path so that it progressively creates a longitudinal fold in the seed tape and progressively pressed forces the folded seed tape into the soil substrate whereby after being pressed into the soil substrate, the longitudinal fold in the seed tape is downwardly oriented and the two edges of the seed tape are upwardly oriented and are below ground level;
wherein the seed tape comprises a polymer film layer having a plurality of seeds at least partially embedded therein, and a porous reinforcing layer bonded to the polymer film layer, and wherein, when the seed tape is folded, the porous reinforcing layer constitutes the inner surface of the folded seed tape so that the seed-containing polymer layer faces outwards.

2. A method according to claim 1, which method further comprises:
(i) providing an apparatus comprising a carriage having mounted thereon a seed tape feeder, and a rotating pressing disc, wherein the apparatus comprises a force adjustment mechanism for adjusting a pressing force exerted by the pressing disc against the soil substrate; and
(ii) using the force adjustment mechanism to select a force setting for the pressing disc to provide a desired degree of penetration of the pressing disc into the soil substrate.

3. A method according to claim wherein the longitudinal fold is made along a line approximating to the centre line of the seed tape.

4. A method according to claim 1 wherein (i) the slit (when present) is formed so that, at an upper end thereof, it has an enlarged region; or (ii) or (ii) when no slit is initially formed but the seed tape is pressed directly into the soil substrate, an enlarged region or channel is created above the folded seed tape after it has been pressed into the soil substrate.

5. A method according to claim 4 wherein the enlarged region has a substantially V-shaped cross section.

6. A method according to claim 1 wherein the depth of the slit (including any enlarged upper end thereof), or the enlarged region or channel as the case may be, is larger than the vertical dimension of the seed tape when it has been pressed into the slit, and is selected such that there is a vertical space beneath the folded seed tape into which the roots of germinating seeds can grow.

7. (canceled)

8. An apparatus for use in sowing seeds in a soil substrate, the seeds being carried by a seed tape; wherein the apparatus comprises a carriage provided with a seed tape feeder bearing the seed tape, and a rotating pressing disc mounted on the carriage; such that, in use:
(i) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the soil substrate as the carriage advances, such that after being pressed into the soil substrate, the longitudinal fold in the seed tape is downwardly oriented and the two edges of the seed tape are upwardly oriented, and there is a vertical gap between the two edges and a surface of the soil substrate;
wherein the apparatus comprises a force adjustment mechanism for adjusting a pressing force exerted by the pressing disc against the soil substrate;
wherein the seed tape comprises a polymer film layer having a plurality of seeds at least partially embedded therein, and a porous reinforcing layer bonded to the polymer film layer; and the seed tape feeder is arranged to deliver the seed tape such that, when the seed tape is folded, the porous reinforcing layer constitutes the inner surface of the folded seed tape so that the seed-containing polymer layer faces outwards.

9. An apparatus according to claim 8 which comprises a rotating soil cutting disc for cutting a slit in advanced of the pressing disc.

10. An apparatus according to claim 8 wherein the pressing disc is arranged to create a longitudinal fold along a line approximating to the centre line of the seed tape.

11. An apparatus according to claim 8 wherein the pressing disc has a surface profile such that (i) during the pressing of the folded seed tape into the slit when present, an upper end of the slit is enlarged laterally; or (ii) when no slit is initially formed, an enlarged region or channel is created above the folded seed tape after it has been pressed into the soil substrate.

12. An apparatus according to claim 11 wherein the surface profile of the pressing disc comprises a shoulder on one or both sides of the pressing disc, which shoulder comes into contact with the upper end of the slit (when present) during the pressing, thereby to enlarge the upper end of the slit laterally, or to form the said enlarged region or channel.

13. An apparatus according to claim 12 wherein sloped shoulders are present on both sides of the pressing disc and are configured to create a substantially V-shaped enlarged region or channel.

14. An apparatus according to claim 9 wherein the seed tape feeder comprises a roll of the seed tape and one or more guide rollers for guiding the seed tape into place.

15. An apparatus according to claim 14 wherein the roll of seed tape is mounted such that the seed tape is initially unwound in a substantially lateral direction, and then using a turn roller to turn the direction of travel of the seed tape through so that it is in-line with the pressing disc.

16. A method for sowing seeds in a soil substrate, the seeds being carried by a seed tape; which method comprises
(i) cutting a longitudinally extending substantially vertical slit along the soil substrate;
(ii) feeding the seed tape in front of a pressing disc and bringing the seed tape into contact with the pressing disc so that a peripheral pressing edge of the pressing disc is substantially centrally aligned between two edges of the seed tape;
(iii) advancing the pressing disc along a path aligned with the slit so that it progressively creates a longitudinal fold in the seed tape and progressively presses the folded seed tape into the slit, whereby, after being pressed into the slit, the longitudinal fold in the seed tape is downwardly oriented and the two edges of the seed tape are upwardly oriented, and there is a vertical gap between the two edges and an upper end of the slit;
wherein the seed tape comprises a polymer film layer having a plurality of seeds at least partially embedded therein, and a porous reinforcing layer bonded to the polymer film layer, and wherein, when the seed tape is folded, the porous reinforcing layer constitutes the inner surface of the folded seed tape so that the seed-containing polymer layer faces outwards.

17. A method according to claim 16 which is performed using an apparatus for use in sowing seeds in a soil substrate, the seeds being carried by a seed tape; wherein the apparatus comprises a carriage provided with a seed tape feeder bearing the seed tape, and a rotating pressing disc mounted on the carriage; such that, in use:
(i) the seed tape is fed in front of the pressing disc by the seed tape feeder and brought into contact with the pressing disc so that a peripheral pressing edge of the pressing disc is substantially centrally aligned between two edges of the seed tape;
(iii) the pressing disc progressively creates a longitudinal fold in the seed tape and progressively presses the folded seed tape into the soil substrate as the carriage advances, such that after being pressed into the soil substrate, the longitudinal fold in the seed tape is downwardly oriented and the two edges of the seed tape are upwardly oriented, and there is a vertical gap between the two edges and a surface of the soil substrate;
wherein the apparatus comprises a force adjustment mechanism for adjusting a pressing force exerted by the pressing disc against the soil substrate;
wherein the seed tape comprises a polymer film layer having a plurality of seeds at least partially embedded therein, and a porous reinforcing layer bonded to the polymer film layer; and the seed tape feeder is arranged to deliver the seed tape such that, when the seed tape is folded, the porous reinforcing layer constitutes the inner surface of the folded seed tape so that the seed-containing polymer layer faces outwards,
wherein the apparatus comprises a rotating soil cutting disc for cutting a slit in advance of the pressing disc.

18. (canceled)

19. A method according to claim 3 wherein the seed tape is formed from a cellulose-based and/or plastics-based material and carries seeds arranged in a row extending along the seed tape, the row being substantially parallel to a longitudinal edge of the seed tape and being spaced apart from the centre line of the seed tape.

20. An apparatus according to claim 10 wherein the seed tape is formed from a cellulose-based and/or plastics-based material and carries seeds arranged in a row extending along the seed tape, the row being substantially parallel to a longitudinal edge of the seed tape and being spaced apart from the centre line of the seed tape.

21. A method according to claim 1 wherein there is provided a force adjustment mechanism comprising a spring and a tensioning device for varying the tension in the spring, the spring being oriented such that the tension in the spring either augments or reduces the force applied by the pressing disc to the soil substrate due to the weight of the pressing disc.

22. An apparatus according to claim 7 which is provided with a force adjustment mechanism comprising a spring and a tensioning device for varying the tension in the spring, the spring being oriented such that the tension in the spring either augments or reduces the force applied by the pressing disc to the soil substrate due to the weight of the pressing disc.
